(19) United States
(12) Patent Application Publication
(10) Pub. No.: US 2023/0150506 A1
(43) Pub. Date: May 18, 2023

(54) NOTIFICATION CONTROL APPARATUS, VEHICLE, NOTIFICATION CONTROL METHOD, AND PROGRAM

(71) Applicant: TOYOTA JIDOSHA KABUSHIKI KAISHA, Toyota-shi (JP)

(72) Inventor: Yoshinari TODA, Nisshin-shi (JP)

(73) Assignee: TOYOTA JIDOSHA KABUSHIKI KAISHA, Toyota-shi (JP)

(21) Appl. No.: 17/980,102

(22) Filed: Nov. 3, 2022

(30) Foreign Application Priority Data
Nov. 12, 2021 (JP) 2021-184490

(51) Int. Cl. B60W 30/18; B60W 50/14; G06V 20/58

(52) U.S. Cl. CPC B60W 30/18154; B60W 50/14; G06V 20/584; B60W 2555/60; B60W 2720/106; B60W 2556/40; B60W 2554/802

(57) ABSTRACT

Disclosed is a notification control apparatus for a vehicle which controls a notification apparatus which gives a notice to a driver. The vehicle has a driving assistance apparatus which includes a first recognition section for recognizing a traffic light present ahead of the vehicle from map data, a second recognition section for recognizing the traffic light present ahead of the vehicle and its indication state, and a deceleration control section which executes deceleration control by using, as a deceleration causing object, a traffic light recognized by the first recognition section and/or the second recognition section. The notification control apparatus includes a control section for controlling the notification apparatus to notify the driver of the deceleration causing object in different manners depending on whether the traffic light recognized by the first recognition section or the traffic light recognized by the second recognition section is used as the deceleration causing object.

### BACKGROUND OF THE INVENTION

### Field of the Invention

The present disclosure relates to a notification control apparatus, a vehicle, a notification control method, and a program.

### Description of the Related Art

Japanese Patent Application Laid-Open (kokai) No. 2018-173723 discloses a driving assistance apparatus which detects a traffic light ahead of a vehicle on the basis of map data during travel of the vehicle, recognizes the lighting color of the traffic light from an image captured by a camera when the traffic light enters the field of view of the camera, and executes deceleration control for stopping the vehicle before reaching the traffic light when the recognized lighting color of the traffic light is red or yellow.

Here, assume the case where the driving assistance apparatus is executing follow-up control for causing the vehicle to follow a preceding vehicle and starts the deceleration control upon detection of a traffic light ahead of the vehicle in the period during which the follow-up control is being executed. In the period during which the follow-up control is being executed, a driver basically entrusts driving operation to the apparatus. However, the driver must monitor the control to determine whether or not the control is performed appropriately, while paying attention to the situation around the vehicle. Therefore, in the case where the apparatus switches the driving assistance control from the follow-up control to the deceleration control upon detection of a traffic light, it is desired for the apparatus to notify the driver that an object which causes the apparatus to decelerate the vehicle (an object which is recognized by the control as one which requires deceleration of the vehicle) has been switched from the preceding vehicle to the traffic light ahead of the vehicle (hereinafter, such an object will be referred to a “deceleration causing object”).

However, merely notifying the driver that the deceleration causing object is a traffic light does not enable the driver to grasp whether the deceleration causing object is a traffic light detected on the basis of the map data or a traffic light whose lighting color is recognized by the camera. If the driver places excessive trust in the control in a state in which the driver does not grasp whether the deceleration causing object is the traffic light detected on the basis of the map data or the traffic light whose lighting color is recognized by the camera, there may arise a possibility of failing to secure safety, for example, in the case where the traffic light in the map data does not coincide with the actually existing traffic light or the case where the camera fails to recognize the lighting color of the traffic light.

### SUMMARY OF THE INVENTION

The present disclosure discloses a technique which has been achieved so as to solve the above-described problem. Namely, an object of the technique is to effectively notify a driver of a deceleration causing object during execution of deceleration control.

A notification control apparatus (10) of the present disclosure is applied to a vehicle (V) and controls a notification apparatus (61) which gives a notice to a driver of the vehicle (V). The vehicle (V) has a driving assistance apparatus (1) which comprises a first recognition section (10, 50) which recognizes a traffic light (S1, S2) present ahead of the vehicle (V) on the basis of map data (51) including pieces of information of traffic lights on a road on which the vehicle (V) travels, a second recognition section (10, 40) which recognizes the traffic light (S1, S2) present ahead of the vehicle (V) and an indication state of the traffic light (S1, S2), and a deceleration control section (10) which executes deceleration control for decelerating the vehicle (V) at a predetermined deceleration rate by using, as a deceleration causing object, a traffic light (S1, S2) which is recognized by at least one of the first recognition section (10, 50) and the second recognition section (10, 40) in a period during which the vehicle (V) is traveling.

The notification control apparatus (10) comprises a control section (10) which controls the notification apparatus (61) to notify the driver of the deceleration causing object associated with the deceleration control in different manners between the case where the deceleration control section (10) executes the deceleration control by using, as the deceleration causing object, the traffic light (S1, S2) recognized by the first recognition section (10, 50) and the case where the deceleration control section (10) executes the deceleration control by using, as the deceleration causing object, the traffic light (S1, S2) recognized by the second recognition section (10, 40).

The deceleration control section (10) executes the deceleration control when at least one of the first recognition section (10, 50) and the second recognition section (10, 40) recognizes a traffic light (S1, S2) in the period during which the vehicle (V) is traveling, and a predetermined condition is satisfied. The deceleration control section (10) executes the deceleration control (gentle deceleration control) when the first recognition section (10, 50) recognizes the traffic light (S1, S2) in the period during which the vehicle (V) is traveling, and there is satisfied a predetermined condition that the vehicle (V) has reached a deceleration start position (Psd1, Psd2) and the vehicle speed (Vs) at that time is higher than a target vehicle speed (V1). The deceleration control section (10) executes the deceleration control (deceleration and stop control) when the vehicle (V) has reached the recognizable position (Pr1, Pr2), the second recognition section (10, 40) recognizes, at that time, the traffic light (S1, S2) and the lighting color of the traffic light (S1, S2), and there is satisfied a predetermined condition that the recognized lighting color is a color other than green.

A notification control method of the present disclosure is applied to a vehicle (V) and controls a notification apparatus (61) which gives a notice to a driver of the vehicle (V). The vehicle (V) has a driving assistance apparatus (1) which comprises a first recognition section (10, 50) which recognizes a traffic light (S1, S2) present ahead of the vehicle (V) on the basis of map data (51) including pieces of information of traffic lights on a road on which the vehicle (V) travels, a second recognition section (10, 40) which recognizes the traffic light (S1, S2) present ahead of the vehicle (V) and an indication state of the traffic light (S1, S2), and a deceleration control section (10) which executes deceleration control for decelerating the vehicle (V) at a predetermined deceleration rate by using, as a deceleration causing object, a traffic light (S1, S2) which is recognized by at least one of the first recognition section (10, 50) and the second recognition section (10, 40) in a period during which the vehicle (V) is traveling.

The notification control method controls the notification apparatus (61) to notify the driver of the deceleration causing object associated with the deceleration control in different manners between the case where the deceleration control section (10) executes the deceleration control by using, as the deceleration causing object, the traffic light (S1, S2) recognized by the first recognition section (10, 50) and the case where the deceleration control section (10) executes the deceleration control by using, as the deceleration causing object, the traffic light (S1, S2) recognized by the second recognition section (10, 40).

A program of the present disclosure is applied to a vehicle (V) and controls a notification apparatus (61) which gives a notice to a driver of the vehicle (V). The vehicle has a driving assistance apparatus (1) which comprises a first recognition section (10, 50) which recognizes a traffic light (S1, S2) present ahead of the vehicle (V) on the basis of map data (51) including pieces of information of traffic lights on a road on which the vehicle (V) travels, a second recognition section (10, 40) which recognizes the traffic light (S1, S2) present ahead of the vehicle (V) and an indication state of the traffic light (S1, S2), and a deceleration control section (10) which executes deceleration control for decelerating the vehicle (V) at a predetermined deceleration rate by using, as a deceleration causing object, a traffic light (S1, S2) which is recognized by at least one of the first recognition section (10, 50) and the second recognition section (10, 40) in a period during which the vehicle (V) is traveling.

The program causes a computer to execute a process of controlling the notification apparatus (61) to notify the driver of the deceleration causing object associated with the deceleration control in different manners between the case where the deceleration control section (10) executes the deceleration control by using, as the deceleration causing object, the traffic light (S1, S2) recognized by the first recognition section (10, 50) and the case where the deceleration control section (10) executes the deceleration control by using, as the deceleration causing object, the traffic light (S1, S2) recognized by the second recognition section (10, 40).

By virtue of the above-described configuration, the notification apparatus (61) notifies the driver of the deceleration causing object in different manners between the case where the deceleration control section (10) executes the deceleration control by using, as the deceleration causing object, the traffic light (S1, S2) recognized by the first recognition section (10, 50) and the case where the deceleration control section (10) executes the deceleration control by using, as the deceleration causing object, the traffic light (S1, S2) recognized by the second recognition section (10, 40). Accordingly, the driver can grasp, without fail, whether the deceleration causing object is the traffic light (S1, S2) recognized by the first recognition section (10, 50) or the traffic light (S1, S2) whose indication state is recognized by the second recognition section (10, 40).

The notification apparatus (61) may be a display apparatus (61) provided at a position determined such that the driver of the vehicle (V) can view the display apparatus (61). In this case, the control section (10) may operate as follows. When the deceleration control is executed by using, as the deceleration causing object, the traffic light (S1, S2) recognized by the first recognition section (10, 50), the control section (10) displays an image (80A) of a traffic light on the display apparatus (61) in such a manner that none of lighting portions of the traffic light is on. When the deceleration control is executed by using, as the deceleration causing object, the traffic light recognized by the second recognition section (10, 40), the control section (10) displays an image (80B) of a traffic light on the display apparatus (61) in such a manner that a lighting portion of the traffic light corresponding to the indication state is on.

In this case, different notification images (80A, 80B) are displayed on the display apparatus (61) depending on whether the traffic light (S1, S2) recognized by the first recognition section (10, 50) or the traffic light (S1, S2) recognized by the second recognition section (10, 40) is used as the deceleration causing object associated with the deceleration control. Accordingly, the driver can easily grasp whether the deceleration causing object is the traffic light (S1, S2) recognized by the first recognition section (10, 50) or the traffic light (S1, S2) whose indication state is recognized by the second recognition section (10, 40), by merely checking the notification image (80A, 80B) displayed on the display apparatus (61).

The deceleration control section (10) may be configured to decelerate the vehicle (V) at different deceleration rates between the case where the deceleration control section (10) executes the deceleration control by using, as the deceleration causing object, the traffic light (S1, S2) recognized by the first recognition section (10, 50) and the case where the deceleration control section (10) executes the deceleration control by using, as the deceleration causing object, the traffic light (S1, S2) recognized by the second recognition section (10, 40).

In this case, the deceleration causing objects used in the deceleration control for decelerating the vehicle (V) at different deceleration rates can be notified to the driver in different manners by the notification apparatus (61). Accordingly, the driver can grasp, without fail, the cause of a change in the deceleration rate of the vehicle (V) during execution of the deceleration control.

The second recognition section (10, 40) may be such that it becomes able to recognize the lighting color of the traffic light (S1, S2) when the distance between the vehicle and a traffic light ahead of the vehicle becomes a predetermined threshold distance (Lr) or shorter. In this case, the deceleration control section may operate as follows. In case where the speed (Vs) of the vehicle (V) is higher than a predetermined target vehicle speed (V1) when the vehicle (V) reaches a predetermined point (Psd) before a point where the distance between the vehicle (V) and the traffic light (S1, S2) recognized by the first recognition section (10, 50) becomes the predetermined threshold distance (Lr) or shorter, the deceleration control section (10) executes first deceleration control (gentle deceleration control) for decelerating the vehicle (V) at a predetermined first deceleration rate (A1) from a point in time when the vehicle (V) reaches the predetermined point (Psd). In the case where the second recognition section (10, 40) recognizes the lighting color of the traffic light (S1, S2) ahead of the vehicle (V) and the recognized lighting color is red or yellow, from a point in time when the lighting color of the traffic light (S1, S2) is recognized, the deceleration control section (10) executes second deceleration control (deceleration and stop control) for decelerating the vehicle (V) at a predetermined second deceleration rate (A2) higher than the first deceleration rate (A1).

In this case, when the vehicle (V) reaches the deceleration start point (Psd) before the recognizable point (Pr), the deceleration control section (10) executes the gentle deceleration control for decelerating the vehicle (V) at the first deceleration rate (A1), and, when the vehicle (V) reaches the recognizable point (Pr) and the second recognition section (10, 40) recognizes at that time that the lighting color of the traffic light (S1, S2) is red or yellow, the deceleration control section (10) executes the deceleration and stop control for decelerating the vehicle (V) at the second deceleration rate (A2) higher than the first deceleration rate (A1). As a result, it becomes possible to stop, without fail, the vehicle (V) at a predetermined stop position (PST1, PST2) before the traffic light (S1, S2).

In the above description, in order to facilitate understanding of the present invention, the constituent elements of the invention corresponding to those of an embodiment of the invention which will be described later are accompanied by parenthesized reference numerals which are used in the embodiment; however, the constituent elements of the invention are not limited to those in the embodiment defined by the reference numerals.

### BRIEF DESCRIPTION OF THE DRAWINGS

FIG. 1 is a schematic overall diagram of an automatic driving system according to an embodiment;

FIG. 2 is an illustration used for describing one example of deceleration control according to the embodiment;

FIG. 3 is an illustration used for describing another example of the deceleration control according to the embodiment;

FIG. 4 is an illustration used for describing still another example of the deceleration control according to the embodiment;

FIG. 5 is an illustration used for describing an example notification image displayed on a display apparatus by an ECU;

FIG. 6 is an illustration used for describing another example notification image displayed on the display apparatus by the ECU;

FIG. 7 is an illustration used for describing still another example notification image displayed on the display apparatus by the ECU;

FIG. 8 is an illustration used for describing still another example notification image displayed on the display apparatus by the ECU;

FIG. 9 is a timing chart used for describing a specific flow of display control;

FIG. 10 is another timing chart used for describing the specific flow of the display control; and

FIG. 11 is a flowchart used for describing a routine (first half) for the deceleration control and the display control according to the embodiment; and

FIG. 12 is a flowchart used for describing a routine (second half) for the deceleration control and the display control according to the embodiment.

### DESCRIPTION OF THE PREFERRED EMBODIMENT

A notification control apparatus, a vehicle, a notification control method, and a program according to an embodiment will now be described with reference to the drawings. Notably, throughout the drawings, the same components are denoted by the same reference numerals, and their names and functions are the same. Therefore, their detailed descriptions will not be repeated.

### [Overall Configuration]

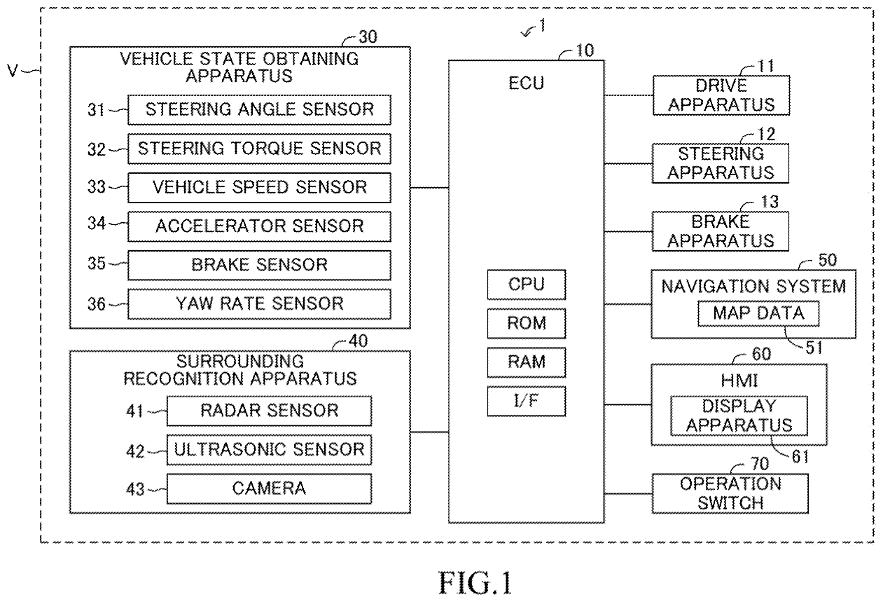

FIG. 1 is a schematic overall diagram of an automatic driving system 1 according to the present embodiment. The automatic driving system 1 is mounted on a vehicle V and includes an ECU 10. The ECU 10 includes a microcomputer as a main component. Notably, ECU is an abbreviation for Electronic Control Unit. The microcomputer includes a CPU, a ROM, a RAM, an interface, etc. The CPU realizes various functions by executing instructions (programs, routines) stored in the ROM.

The ECU 10 executes automatic driving control for the vehicle V. Herein, “automatic driving control” is a concept which encompasses driving assistance control. Examples of the driving assistance control include adaptive cruise control (hereinafter referred to as “ACC”), path following control, etc. The ACC is a control for causing the vehicle V to travel in different ways depending on whether or not another preceding vehicle is traveling ahead of the vehicle V. In the case where the preceding vehicle is present, the ACC causes the vehicle V to follow the preceding vehicle while maintaining the distance between the preceding vehicle and the vehicle V at a set inter-vehicle distance. In the case where no preceding vehicle is present, the ACC causes the vehicle V to travel at a set vehicle speed; i.e., travel at a constant speed. The path following control is a control for automatic travel which causes the vehicle V to follow a target track (target path). In the present embodiment, the driving assistance control may be either of the ACC and the path following control. However, in the following description, the ACC will be described as one example of the driving assistance control.

The ECU 10 performs the ACC by controlling the operations of a drive apparatus 11, a steering apparatus 12, a brake apparatus 13, etc. on the basis of the travel state of the vehicle V and the circumstances around the vehicle V. Therefore, the drive apparatus 11, the steering apparatus 12, the brake apparatus 13, a vehicle state obtaining apparatus 30, a surrounding recognition apparatus 40, a navigation system 50, an HMI (Human Machine Interface) 60, an operation switch 70, etc. are communicably connected to the ECU 10.

The drive apparatus 11 generates drive power which is transmitted to drive wheels of the vehicle V. The drive apparatus 11 is, for example, an electric motor or an engine. The vehicle V may be any of a hybrid vehicle (HEV), a plug-in hybrid vehicle (PHEV), a fuel cell vehicle (FCEV), a battery electric vehicle (BEV), and an engine vehicle. The steering apparatus 12 is, for example, an electric power steering apparatus and applies steering forces to steerable wheels of the vehicle V. The brake apparatus 13 is, for example, a disc-type brake apparatus and applies braking forces to the wheels of the vehicle V.

The vehicle state obtaining apparatus 30 is a group of sensors for obtaining the state of the vehicle V. Specifically, the vehicle state obtaining apparatus 30 includes a steering angle sensor 31, a steering torque sensor 32, a vehicle speed sensor 33, an accelerator sensor 34, a brake sensor 35, a yaw rate sensor 36, etc.

The steering angle sensor 31 detects the steering angle of an unillustrated steering wheel (or an unillustrated steering shaft). The steering torque sensor 32 detects a steering torque which acts on the steering shaft (not shown) of the vehicle V as a result of operation of the steering wheel. The vehicle speed sensor 33 detects the travel speed of the vehicle V (vehicle speed). The vehicle speed sensor 33 may be a wheel speed sensor. The accelerator sensor 34 detects the operation amount of an unillustrated accelerator pedal. The brake sensor 35 detects the operation amount of an unillustrated brake pedal. The yaw rate sensor 36 detects the yaw rate of the vehicle V. The pieces of information representing the state of the vehicle V and obtained by the vehicle state obtaining apparatus 30 are transmitted to the ECU 10.

The surrounding recognition apparatus 40 is a group of sensors for recognizing objects around the vehicle V and outputting pieces of object information relating to the objects. Specifically, the surrounding recognition apparatus 40 includes a radar sensor 41, an ultrasonic sensor 42, a camera 43, etc. Examples of the pieces of object information include pieces of information relating to vehicles around the vehicle V, pieces of information relating to traffic lights, pieces of information relating to white lines on roads, pieces of information relating to signs, and pieces of information relating to fallen objects. The pieces of object information relating to the objects around the vehicle V and obtained by the surrounding recognition apparatus 40 are transmitted to the ECU 10.

The radar sensor 41 includes a radar transmitting/receiving section and a signal processing section (not shown). The radar transmitting/receiving section radiates a radio wave in the millimeter wave band (hereinafter referred to as “millimeter wave”) to a region around the vehicle V and receives a millimeter wave (i.e., reflection wave) reflected by a three-dimensional object present in the region to which the millimeter wave is radiated. On the basis of the phase difference between the transmitted millimeter wave and the received reflection wave, the level of attenuation of the reflection wave, the time elapsed until the radar transmitting/receiving section received the reflection wave after having transmitted the millimeter wave, etc., the signal processing section obtains pieces of information representing the distance between the vehicle V and the three-dimensional object, the relative speed of the vehicle V in relation to the three-dimensional object, the relative position (direction) of the three-dimensional object in relation to the vehicle V, etc. The signal processing section outputs the pieces of information to the ECU 10.

The ultrasonic sensor 42 transmits an ultrasonic wave in the shape of pulses to a predetermined range around the vehicle V and receives a reflection wave; i.e., the ultrasonic wave reflected by a three-dimensional object. On the basis of the time between transmission of the ultrasonic wave and reception of the reflection wave, the ultrasonic sensor 42 can detect a refection point (i.e., a point on the three-dimensional object at which the transmitted ultrasonic wave is reflected), the distance between the ultrasonic sensor 42 and the three-dimensional object, etc.

The camera 43 is disposed, for example, on an upper portion of a front windshield glass of the vehicle V. The camera 43 captures images of scenes around the vehicle V and processes data of the captured images, thereby obtaining pieces of information relating to objects present around the vehicle V (hereinafter referred to as “object information”). The camera 43 is, for example, a stereo camera or a monocular camera, and a digital camera including an imaging device such as CMOS or CCD can be used.

In the present embodiment, the camera 43 analyses image data obtained by photographing a scene in front of the vehicle V at a predetermined frame rate, and obtains, from the image of the scene, the lighting color of a traffic light located ahead of the vehicle V in the travel direction of the vehicle V. Notably, the vehicle V must get closer to the traffic light to some extent so as to allow the camera 43 to accurately determine whether or not a group of red, yellow, or green pixels which are contained in the image data and form a circular shape corresponds to the light emitted from the corresponding lighting portion of the traffic light. For example, when the vehicle V approaches a traffic light and the distance between the vehicle V and the traffic light becomes a predetermined distance, the camera 43 becomes able to accurately determine the lighting color of the traffic light. In the following description, the maximum value of the distance (the distance between the vehicle V and the traffic light), below which the camera 43 can accurately determine the lighting color of the traffic light, will be referred to as a “recognizable distance Lr.” Also, a point which is located before the traffic light and at the recognizable distance Lr from the traffic light will be referred to as a “recognizable point Pr.” Notably, the recognizable distance Lr depends on the specifications of the camera 43. Therefore, the recognizable distance Lr is experimentally obtained in the stage of developing the vehicle V, and the obtained recognizable distance Lr is stored in the ROM of the ECU 10 beforehand.

The navigation system 50 receives GPS signals from a plurality of artificial satellites and detects the present position VP (latitude and longitude) of the vehicle V on the basis of the received GPS signals. Also, the navigation system 50 stores map data 51 which represents a map. The map data 51 includes pieces of road information representing roads, and pieces of traffic light position information representing positions where traffic lights are provided, etc. The navigation system 50 transmits to the ECU 10 vehicle position data representing the detected present position VP of the vehicle V. Furthermore, the navigation system 50 has a function of calculating the distance (the distance along a road) between two points. For example, the navigation system 50 computes the distance between the present position VP of the vehicle V and a traffic light (nearest traffic light) which the vehicle V first passes when the vehicle V travels straight along the road on which the vehicle V currently travels. The navigation system 50 transmits data representing the computed distance to the ECU 10.

The HMI 60 is an interface for exchanging pieces of information between the ECU 10 and the driver through input and output of data. Specifically, the HMI 60 has an input apparatus and an output apparatus. Examples of the input apparatus include a touch panel and a switch. Examples of the output apparatus include a display apparatus 61 and a speaker. Examples of the display apparatus 61 include a display of the navigation system 50 disposed on an instrument panel or the like and a head-up display.

The operation switch 70 is an operating element (for example, a push-button-type switch operating element) which the driver operates when the driver requests start and end of the ACC. In the case where the driver operates the operation switch 70 (presses the button) in a period during which the ACC is not executed, the operation switch 70 transmits an ACC start signal to the ECU 10. The ACC start signal represents “that the driver requests start of the ACC (ACC start request).” Meanwhile, in the case where the driver operates the operation switch 70 in a period during which the ACC is being executed, the operation switch 70 transmits an ACC end signal to the ECU 10. The ACC end signal represents “that the driver requests end of the ACC (ACC end request).” Also, the operation switch 70 includes operation elements for selecting a set inter-vehicle distance Dd between the vehicle V and a preceding vehicle and a set vehicle speed Vd for constant speed travel. The set inter-vehicle distance Dd and the set vehicle speed Vd are used in the ACC, which will be described later.

### [ACC]

Upon reception of the ACC start signal from the operation switch 70, the ECU 10 executes the ACC. Specifically, on the basis of the information obtained from the surrounding recognition apparatus 40, the ECU 10 determines whether or not another vehicle (preceding vehicle) to follow is present. In the case where the ECU 10 determines that a preceding vehicle to follow is present, the ECU 10 detects the inter-vehicle distance between the preceding vehicle and the vehicle V (the driver's vehicle) on the basis of the information obtained from the surrounding recognition apparatus 40 and controls the operations of the drive apparatus 11 and the brake apparatus 13 such that the inter-vehicle distance becomes equal to the set inter-vehicle distance Dd selected as a result of the operation switch 70 being operated. Hereinafter, the control for causing the vehicle V to follow the preceding vehicle will be referred to simply as “follow-up control.” Meanwhile, in the case where the ECU 10 determines that no preceding vehicle to follow is present, the ECU 10 controls the operations of the drive apparatus 11, the brake apparatus 13, etc. such that the speed Vs of the vehicle V becomes equal to the set vehicle speed Vd selected as a result of the operation switch 70 being operated. Hereinafter, the control for causing the vehicle V to travel at the set vehicle speed Vd (i.e., travel at a constant speed) will be referred to simply as “constant speed travel control.” Also, when the ECU 10 detects a traffic light as a deceleration causing object in a period during which the ECU 10 is executing the ACC, the ECU 10 performs deceleration control for decelerating the vehicle V even when the preceding vehicle does not start deceleration. The details of the deceleration control will now be described.

### [Deceleration Control]

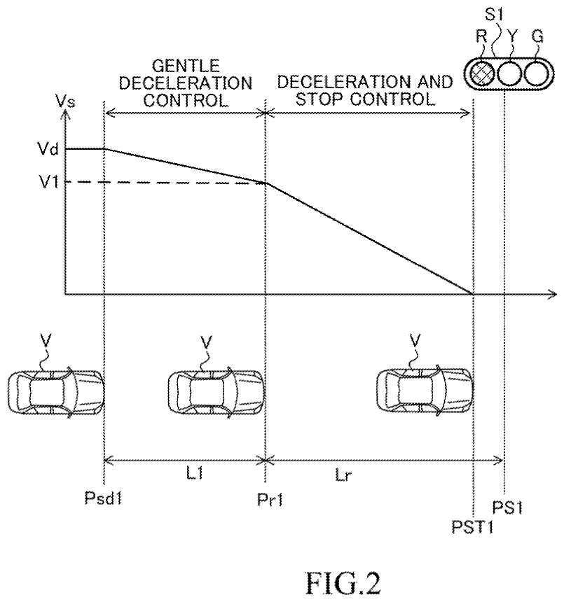

FIG. 2 is an illustration used for describing one example of the deceleration control according to the present embodiment. During a period during which the ECU 10 is executing the ACC, on the basis of the map data 51 of the navigation system 50 and the present position VP of the vehicle V, the ECU 10 obtains a point PS1 where a traffic light S1 located ahead of the vehicle V and closest to the vehicle V is provided and a recognizable point Pr1 corresponding to the traffic light S1. Also, the ECU 10 obtains the present position VP of the vehicle V from the navigation system 50 at predetermined intervals. Furthermore, the ECU 10 obtains the speed Vs of the vehicle V from the vehicle speed sensor 33 at predetermined intervals.

The ECU 10 controls the operations of the drive apparatus 11, the brake apparatus 13, etc. before the vehicle V reaches the recognizable point Pr1 such that, at a point in time when the vehicle V reaches the recognizable point Pr1, the vehicle speed Vs becomes equal to or lower than a predetermined target vehicle speed V1. The target vehicle speed V1 is set beforehand to be a speed which makes it possible to decelerate the vehicle V from the recognizable point Pr1 at a deceleration rate which does not give an unpleasant feeling to the driver (hereinafter referred to as the “second deceleration rate A2”) and stop the vehicle Vat a predetermined stop position PST1 (for example, a stop line associated with the traffic light S1) before the traffic light S1.

Specifically, in the case where the vehicle speed Vs before the recognizable point Pr1 is higher than the target vehicle speed V1, when the vehicle V reaches a predetermined deceleration start point Psd1 before the recognizable point Pr1, the ECU 10 executes gentle deceleration control for decelerating the vehicle V at a predetermined deceleration rate (hereinafter referred to as the “first deceleration rate A1”) smaller than the second deceleration rate A2. The magnitude (absolute value) of the first deceleration rate A1 is, for example, 0.1 G (G: gravitational acceleration). Notably, the first deceleration rate A1 may be smaller than 0.1 G.

The ECU 10 computes the deceleration start point Psd1 located before the recognizable point Pr1 as follows. First, the ECU 10 computes a distance L1 over which the vehicle V travels until the vehicle speed Vs becomes equal to the target vehicle speed V1 in the case where the vehicle V decelerates from the current vehicle speed Vs at the first deceleration rate A1. Subsequently, the ECU 10 determines, as a deceleration start point Psd1 corresponding to the current vehicle speed Vs, a point located before the recognizable point Pr1 and at the distance L1 from the recognizable point Pr1. The ECU 10 repeatedly computes (updates) the deceleration start point Psd1 at predetermined computation intervals.

In the case where the vehicle speed Vs is higher than the target vehicle speed V1 when the vehicle V reaches the deceleration start point Psd1 (the present position VP of the vehicle V obtained from the navigation system 50 coincides with the deceleration start point Psd1), the ECU 10 executes the gentle deceleration control for decelerating the vehicle V at the first deceleration rate A1 from the point in time when the vehicle V reaches the deceleration start point Psd1. Meanwhile, in the case where the vehicle speed Vs is equal to or lower than the target vehicle speed V1 when the vehicle V reaches the deceleration start point Psd1, the ECU 10 does not execute the gentle deceleration control.

When the vehicle V reaches the recognizable point Pr1, the ECU 10 obtains the lighting color of the traffic light S1 from the camera 43. In the case where the obtained lighting color is red (R) or yellow (Y), the ECU 10 executes deceleration and stop control for decelerating the vehicle V at the second deceleration rate A2 and stopping the vehicle V at the stop position PST1 before the traffic light S1 (point PS1).

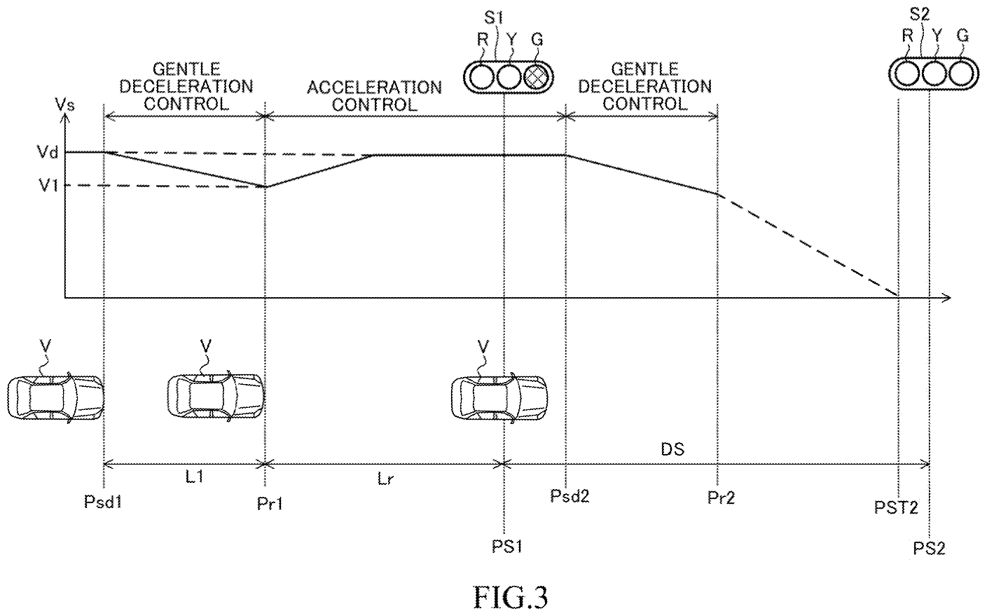

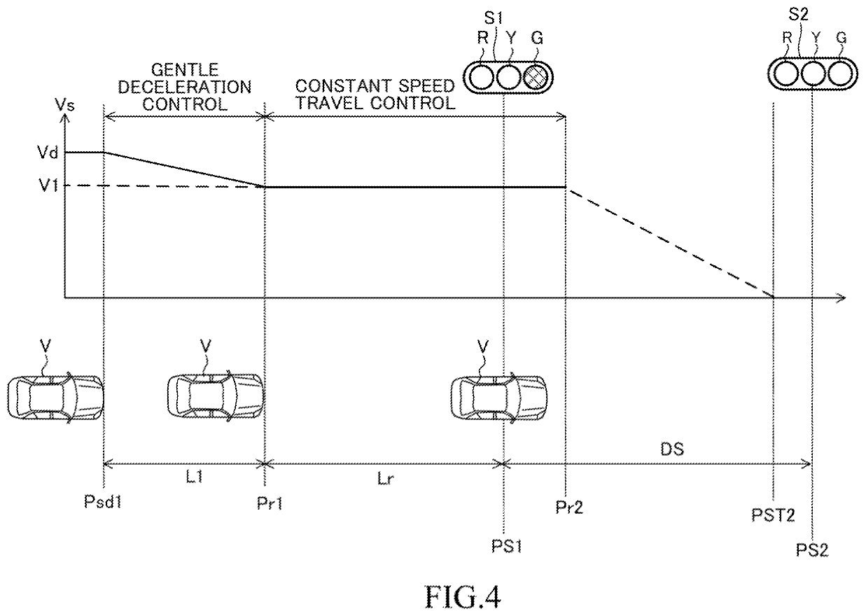

Meanwhile, in the case where, as shown in FIGS. 3 and 4, the lighting color of the traffic light S1 obtained from the camera 43 when the vehicle V reaches the recognizable point Pr1 associated with the closest traffic light S1 is green (G), on the basis of the map data 51 of the navigation system 50, the ECU 10 obtains the distance DS between the closest traffic light S1 and the next traffic light S2 located ahead of and adjacent to the traffic light S1. Also, the ECU 10 determines whether the distance DS is relatively long or relatively short by comparing the obtained distance DS with a predetermined threshold distance DSth. The threshold distance DSth may be set by using, as a reference, for example, a distance determined such that, when the gentle deceleration control and the deceleration and stop control are executed in a state in which the vehicle speed Vs has been increased to the set speed Vd of the ACC, the vehicle V can stop at a predetermined stop position PST2 (for example, the stop line associated with the traffic light S2) before the next traffic light S2. Such distance is equivalent to the sum of the distance L1 and the recognizable distance Lr.

In the case where the distance DS is relatively long as shown in FIG. 3; specifically, the distance DS is longer than the predetermined threshold distance DSth (DS>DSth), the ECU 10 causes the vehicle V to accelerate from the recognizable point Pr1, at which the ECU 10 obtains the lighting color (green (G)) of the traffic light S1 from the camera 43 and pass the traffic light S1, and starts computation of a deceleration start point Psd2 associated with the next traffic light S2. Notably, the upper limit of the vehicle speed Vs at that time is the set vehicle speed Vd of the ACC. When the vehicle V reaches the deceleration start point Psd2, the ECU 10 executes the gentle deceleration control. When the vehicle V reaches the recognizable point Pr2 associated with the traffic light S2, the ECU 10 obtains the lighting color of the traffic light S2 from the camera 43. Subsequently, at the point in time when the ECU 10 succeeds in obtaining the lighting color of the traffic light S2, in accordance with the lighting color, the ECU 10 executes control similar to the control performed when the vehicle V passes the traffic light S1 or stops at the traffic light S1.

In the case where the distance DS is relatively short as shown in FIG. 4; specifically, the distance DS is equal to or shorter than the threshold distance DSth (DS 5 DSth), the ECU 10 causes the vehicle V to travel at a constant speed and pass the traffic light S1. Namely, the vehicle speed Vs at the time when the vehicle V passes the traffic light S1 is the vehicle speed Vs at the point in time when the vehicle V has reached the recognizable point Pr1 (namely, the target speed V1). In this case, the vehicle speed Vs has been reduced enough so that, when the lighting color of the next traffic light S2 becomes red (R) or yellow (Y), the ECU 10 can stop the vehicle V at the stop position PST2 associated with the traffic light S2. Therefore, the ECU 10 omits computation of the deceleration start point Psd2 associated with the traffic light S2. After the vehicle V has passed the traffic light S1, the ECU 10 attempts to obtain the lighting color of the traffic light S2 from the camera 43 at predetermined time intervals. At the point in time when the ECU 10 has succeeded in obtaining the lighting color of the traffic light S2, in accordance with the lighting color, the ECU 10 executes control similar to the control performed when the vehicle V passes the traffic light S1 or stops at the traffic light S1.

Incidentally, because of a topographical reason, for example, because the road on which the vehicle V is traveling is not a simple straight road but the road contains curved portions before the traffic lights S1 and S2, in some times, the camera 43 fails to recognize the lighting color of the traffic light S1 or S2 at a point in time when the vehicle V reaches the recognizable point Pr1 or Pr2. In such a case, the ECU 10 assumes that the lighting color of the traffic light S1 or S2 is red or yellow and decelerates the vehicle V at the second deceleration rate A2 from the recognizable point Pr1 or Pr2. In the case where the camera 43 becomes able to recognize the lighting color of the traffic light S1 or S2 as a result of further advancement of the vehicle V and the lighting color of the traffic light S1 or S2 at that time is red or yellow, the ECU 10 further decelerates the vehicle V at the second deceleration rate A2, and stops the vehicle V at the stop position PST1 or PST2 before the traffic light S1 or S2. Meanwhile, in the case where the lighting color of the traffic light S1 or S2 at the point in time when the camera 43 becomes able to recognize the lighting color is green, the ECU 10 causes the vehicle V to pass the traffic light S1 or S2 while traveling at a constant speed.

Here, assume the case where, in the period during which the ACC is being executed, the ECU 10 switches the driving assistance control from the ACC to the deceleration control (the gentle deceleration control or the deceleration and stop control) upon detection of the traffic light S1 or S2 located ahead of the vehicle V. The driver basically entrusts the driving operation of the vehicle V to the ECU 10 not only in the period during which the ACC is being executed but also after the driving assistance control has been switched from the ACC to the deceleration control. However, the driver must monitor the control to determine whether or not the control is performed appropriately, while checking the situation around the vehicle V. Therefore, in the case where the ECU 10 switches the driving assistance control from the ACC to the deceleration control, it is desired for the ECU 10 to appropriately notify the driver that the deceleration causing object has been switched from the preceding vehicle to the traffic light S1 or S2 ahead of the vehicle V.

However, in the case where the ECU 10 merely notifies the driver that the deceleration causing object is the traffic light S1 or S2 does not allow the driver to grasp whether the deceleration causing object is the traffic light S1 or S2 detected on the basis of the map data 51 of the navigation system 50 or the traffic light S1 or S2 whose lighting color (red or yellow) is recognized by the camera 43. If the driver places excessive trust in the deceleration control in a state in which the driver cannot grasp the deceleration causing object, there may arise a possibility of failing to secure safety, for example, in the case where the traffic light S1 or S2 in the map data 51 does not coincide with the actually existing traffic light S1 or S2 or the case where the camera 43 fails to recognize the lighting color of the traffic light S1 or S2 due to environmental conditions and/or a topographical reason.

In order to solve such a problem, during execution of the deceleration control, the ECU 10 of the present embodiment executes display control for displaying the deceleration causing object on the display apparatus 61, thereby appropriately notifying the driver of the deceleration causing object. The details of the display control will now be described. Notably, for notification to the driver, a sound produced by a speaker can be used additionally. However, in the below, the case where notification to the driver is made by notification images displayed on the display apparatus 61 will be described as one example.

### [Display Control]

FIGS. 5 to 8 are illustrations used for describing notification images displayed on the display apparatus 61 by the ECU 10. Each of notification images 80A to 80D is a graphic image which imitates a traffic light and which has a housing portion 81 (corresponding to the housing of the traffic light) and three light portions 82, 83, and 84. In the illustrated examples, the three light portions 82, 83, and 84 are provided in the housing portion 81 such that the three light portions 82, 83, and 84 are arranged in series in the horizontal direction. However, the three light portions 82, 83, and 84 may be arranged in the vertical direction. Of these light portions 82, 83, and 84, the light portion 82 corresponds to green, the light portion 83 corresponds to yellow, and the light portion 84 corresponds to red.

The notification image 80A shown in FIG. 5 is an image which shows a state in which none of the three light portions 82, 83, and 84 is on by displaying the three light portions 82, 83, and 84 in black, gray, or the same color as the housing portion 81 (hereinafter, the notification image 80A will be referred to as the “no light portion lighting image 80A”). The no light portion lighting image 80A is displayed on the display apparatus 61 by the ECU 10 when the ECU 10 notifies the driver that an object recognized for the deceleration control is the traffic light S1 or S2 detected on the basis of the map data 51 of the navigation system 50.

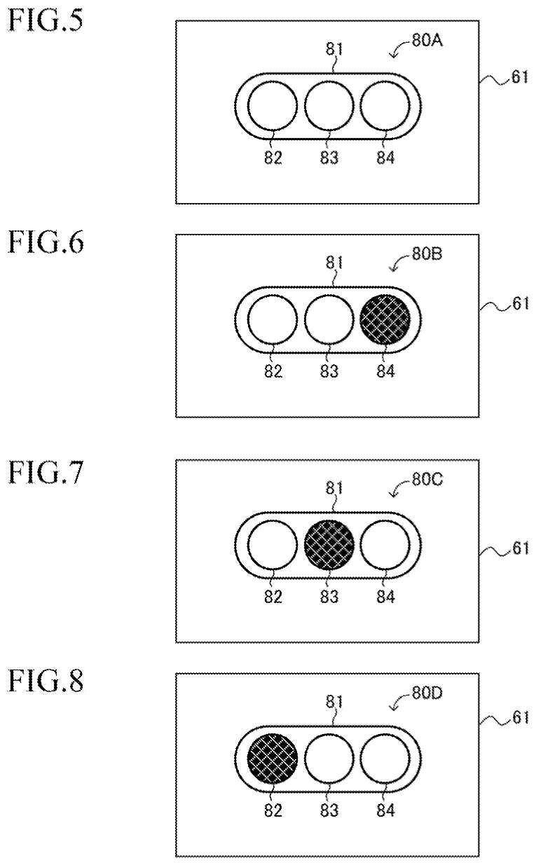

The notification image 80B shown in FIG. 6 is an image which shows a state in which a red signal light is on by displaying the light portion 84 in red and displaying the remaining two light portions 82 and 83 in the same color as the housing portion 81 or in a color other than red (hereinafter, the notification image 80B will be referred to as the “red light portion lighting image 80B”). The notification image 80C shown in FIG. 7 is an image which shows a state in which a yellow signal light is on by displaying the light portion 83 in yellow and displaying the remaining two light portions 82 and 84 in the same color as the housing portion 81 or in a color other than yellow (hereinafter, the notification image 80C will be referred to as the “yellow light portion lighting image 80C”). The red light portion lighting image 80B (or the yellow light portion lighting image 80C) is displayed on the display apparatus 61 by the ECU 10 when the ECU 10 notifies the driver that the object recognized for the deceleration control is the traffic light S1 or S2 which is recognized by the camera 43 to light in red (or yellow).

The notification image 80D shown in FIG. 8 is an image which shows a state in which a green signal light is on by displaying the light portion 82 in green and displaying the remaining two light portions 83 and 84 in the same color as the housing portion 81 or in a color other than green (hereinafter, the notification image 80D will be referred to as the “green light portion lighting image 80D”). The green light portion lighting image 80D is displayed on the display apparatus 61 by the ECU 10, when the ECU 10 causes the vehicle V to pass the traffic light S1 or S2 while causing the vehicle V to travel at the target speed V1 (i.e., at a constant speed), so as to notify the driver that an object recognized for the constant speed travel control is the traffic light S1 or S2 which is recognized by the camera 43 to light in green.

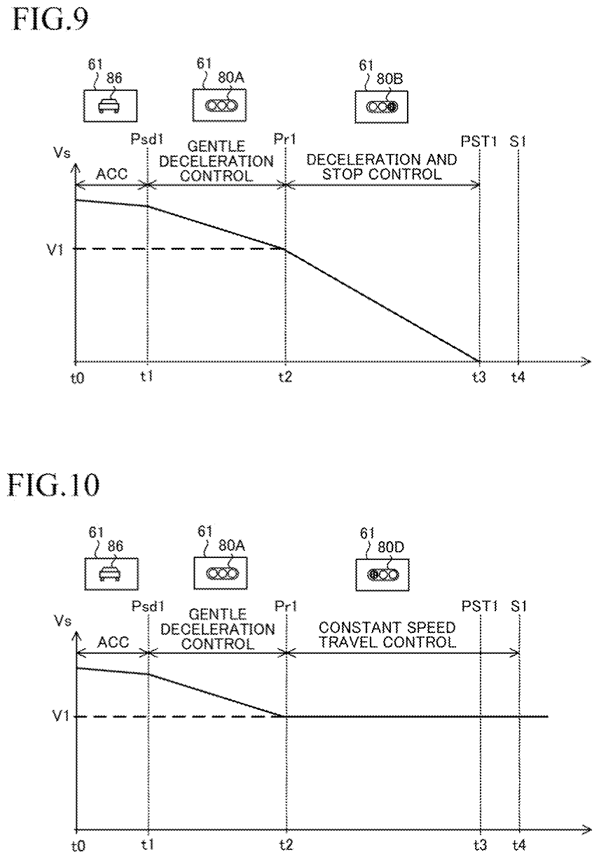

In the case where the ECU 10 executes the gentle deceleration control upon determination that the vehicle V has reached the deceleration start point Psd1 or Psd2, the ECU 10 displays the no light portion lighting image 8A on the display apparatus 61 over the period during which the gentle deceleration control is executed. Also, in the case where the ECU 10 executes the deceleration and stop control upon determination that the vehicle V has reached the recognizable point Pr1 or Pr2 and that the lighting color of the traffic light S1 or S2 recognized by the camera 43 is red (R) (or yellow (Y)), the ECU 10 displays the red light portion lighting image 80B (or the yellow light portion lighting image 80C) on the display apparatus 61 over the period during which the deceleration and stop control is executed. The specific flow of the display control will now be described on the basis of the timing charts of FIGS. 9 and 10.

During the period between time t0 and time t1 shown in FIGS. 9 and 10, the ECU 10 causes the vehicle V to travel by the ACC. In the case where the ACC is the follow-up control, the ECU 10 displays a preceding vehicle follow-up image 86 on the display apparatus 61 as a notification image which shows that the deceleration causing object is a preceding vehicle. In the case where the vehicle V reaches the deceleration start point Psd1 at time t1 and the vehicle speed Vs at that time is higher than the target speed V1, the ECU 10 starts the gentle deceleration control.

When the gentle deceleration control is started, the ECU 10 displays the no light portion lighting image 80A on the display apparatus 61 from time t1. As a result, the driver can grasp that the deceleration causing object has been switched from the preceding vehicle to the traffic light S1 detected by the navigation system 50. The no light portion lighting image 80A displayed on the display apparatus 61 from time t1 is continuously displayed on the display apparatus 61 over the period between time t1 and a point in time when the vehicle V reaches the recognizable point Pr1 and the camera 43 recognizes the lighting color of the traffic light S1.

When the vehicle V reaches the recognizable point Pr1 at time t2, the ECU 10 obtains the lighting color of the traffic light S1 from the camera 43. In the case where the obtained lighting color is red (or yellow), as shown in FIG. 9, the ECU 10 executes the deceleration and stop control for stopping the vehicle V at the stop position PST1 before the traffic light S1. The ECU 10 continuously displays the red light portion lighting image 80B on the display apparatus 61 over the period between time t2 and time t3 when the vehicle V stops at the stop position PST1. As a result, at or after t2, the driver can grasp that the deceleration causing object has been switched to the traffic light S1 recognized by the camera 43. The red light portion lighting image 80B displayed on the display apparatus 61 may be deleted when the vehicle V stops at the stop position PST1 or immediately when the lighting color of the traffic light S1 is switched from red to green.

Meanwhile, in the case where the lighting color obtained at time t2 is green, as shown in FIG. 10, the ECU 10 causes the vehicle V to pass the traffic light S1 while causing the vehicle V to travel at the vehicle speed at that time (the target speed V1) (i.e., at a constant speed). The ECU 10 displays the green light portion lighting image 80D on the display apparatus 61 over the period between time t2 and time t4 when the vehicle V passes the traffic light S1. As a result, the driver can grasp that the ECU 10 causes the vehicle V to travel at the constant speed while recognizing that the lighting color of the traffic light S1 is green G by using the camera 43. The green light portion lighting image 80D displayed on the display apparatus 61 may be deleted immediately when the vehicle V passes the traffic light S1.

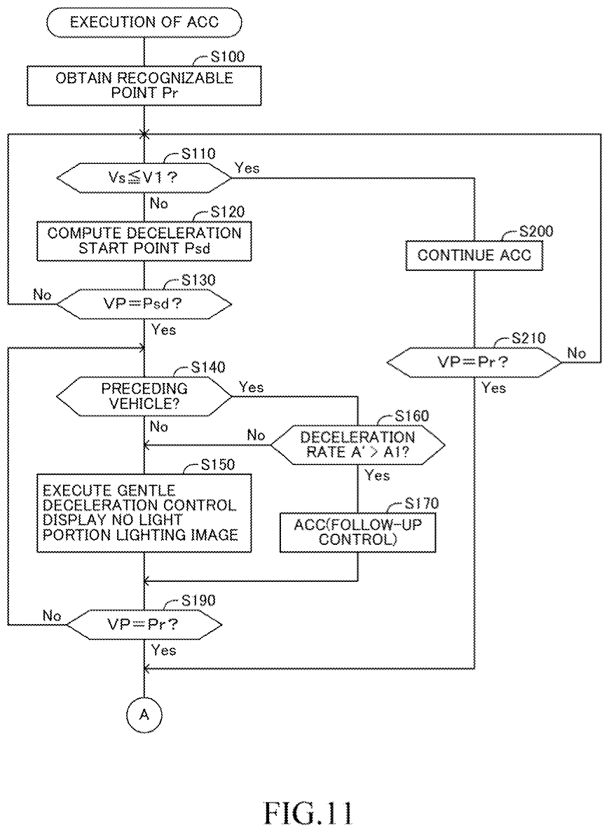

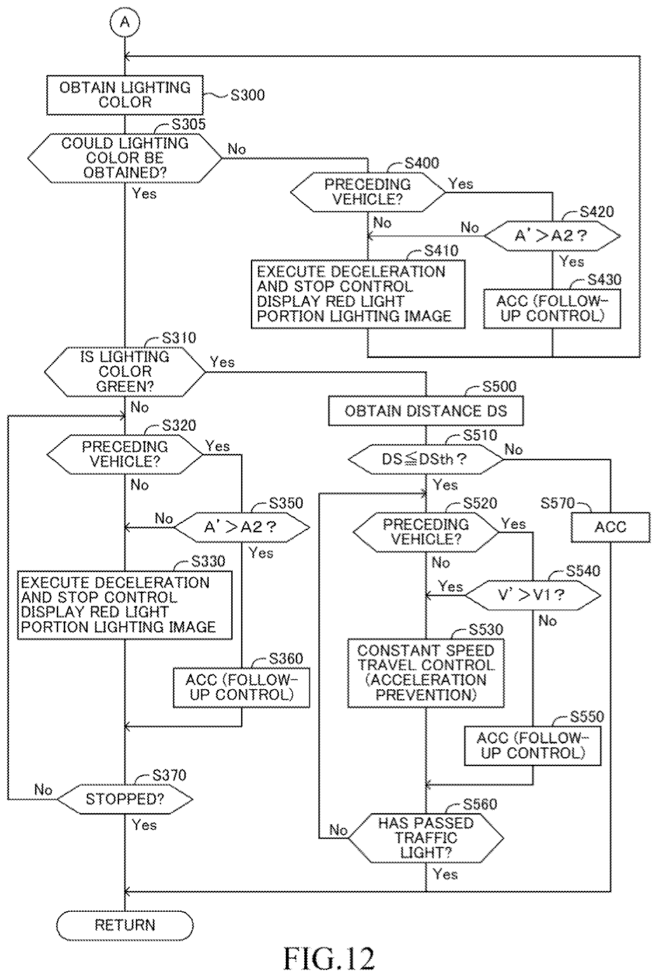

Next, a routine for the deceleration control and the display control, which is performed by the ECU 10, will be described on the basis of the flowcharts shown in FIGS. 11 and 12. This routine is started when the ECU 10 executes the ACC.

In step S100, the ECU 10 obtains the recognizable point Pr corresponding to the closest traffic light S located ahead of the vehicle V on the basis of the map data 51 of the navigation system 50 and the present position VP of the vehicle V.

Next, in step S110, the ECU 10 determines whether or not the vehicle speed Vs obtained by the vehicle speed sensor 33 is equal to or lower than the target speed V1 determined such that, when the deceleration and stop control is executed from the recognizable point Pr, the vehicle V can be stopped at the stop position PST before the traffic light S. In the case where the vehicle speed Vs is equal to or lower than the target speed V1 (Yes), it is unnecessary to execute the gentle deceleration control before reaching the recognizable point Pr. In this case, the ECU 10 proceeds to step S200. Meanwhile, in the case where the vehicle speed Vs is not equal to or lower than the target speed V1 (No); namely, in the case where the vehicle speed Vs is higher than the target speed V1, the ECU 10 proceeds to step S120.

In step S200, the ECU 10 executes the ACC continuously. Namely, in the case where no preceding vehicle to follow is present, the ECU 10 executes the constant speed travel control, and, in the case where a preceding vehicle to follow is present, the ECU 10 executes the follow-up control.

In step S210, the ECU 10 determines whether or not the present position VP of the vehicle V coincides with the recognizable point Pr; i.e., whether or not the vehicle V has reached the recognizable point Pr. In the case where the vehicle V has reached the recognizable point Pr (Yes), the ECU 10 proceeds to step S300 of the deceleration and stop control shown in FIG. 12. Meanwhile, in the case where the vehicle V has not yet reached the recognizable point Pr (No), the ECU 10 returns to step S110.

In the case where the ECU 10 determines in step S110 that the vehicle speed Vs is not equal to or lower than the target speed V1 and proceeds to step S120, the ECU 10 computes the deceleration start point Psd for starting the gentle deceleration control. Next, in step S130, the ECU 10 determines whether or not the present position VP of the vehicle V coincides with the deceleration start point Psd; i.e., whether or not the vehicle V has reached the deceleration start point Psd. In the case where the vehicle V has reached the deceleration start point Psd (Yes), the ECU 10 proceeds to step S140. Meanwhile, in the case where the vehicle V has not yet reached the deceleration start point Psd (No), the ECU 10 returns to step S110.

In step S140, the ECU 10 determines whether or not any preceding vehicle to follow by the ACC is present. In the case where a preceding vehicle to follow is present (Yes), the ECU 10 proceeds to step S160. Meanwhile, in the case where no preceding vehicle to follow is present (No), the ECU 10 proceeds to step S150.

In step S160, the ECU 10 determines whether or not the deceleration rate A′ (absolute value) of the preceding vehicle is higher than the first deceleration rate A1 (absolute value) used in the gentle deceleration control. In the case where the deceleration rate A′ of the preceding vehicle is higher than the first deceleration rate A1, if the gentle deceleration control is executed, the inter-vehicle distance between the vehicle V and the preceding vehicle becomes shorter than the set inter-vehicle distance Dd. In this case, the ECU 10 proceeds to step S170 so as to execute the follow-up control by the ACC. At that time, preferably, the ECU 10 displays on the display apparatus 61 the preceding vehicle follow-up image 86 (see FIGS. 9 and 10) which notifies the driver that the deceleration causing object is the preceding vehicle.

Next, in step S190, the ECU 10 determines whether or not the present position VP of the vehicle V coincides with the recognizable point Pr; i.e., whether or not the vehicle V has reached the recognizable point Pr. In the case where the vehicle V has reached the recognizable point Pr (Yes), the ECU 10 proceeds to step S300 of the deceleration and stop control shown in FIG. 12. Meanwhile, in the case where the vehicle V has not yet reached the recognizable point Pr (No), the ECU 10 returns to step S140.

In the case where the ECU 10 determines in step S160 that the deceleration rate A′ of the preceding vehicle is equal to or lower than the first deceleration rate A1 (No), the ECU 10 must execute the gentle deceleration control even when the preceding vehicle does not decelerate. In this case, the ECU 10 proceeds to step S150.

In step S150, the ECU 10 executes the gentle deceleration control for decelerating the vehicle V at the first deceleration rate A1 so that the vehicle speed Vs decreases to the target speed V1. Also, the ECU 10 displays on the display apparatus 61 the no light portion lighting image 80A (see FIG. 5) which notifies the driver that the deceleration causing object is the traffic light S detected by the navigation system 50. Namely, the ECU 10 notifies the driver that the deceleration causing object is the traffic light S detected by the navigation system 50.

In step S190, the ECU 10 determines whether or not the present position VP of the vehicle V coincides with the recognizable point Pr; i.e., whether or not the vehicle V has reached the recognizable point Pr. In the case where the vehicle V has reached the recognizable point Pr (Yes), the ECU 10 proceeds to step S300 of the deceleration and stop control shown in FIG. 12. Meanwhile, in the case where the vehicle V has not yet reached the recognizable point Pr (No), the ECU 10 returns to step S140.

As shown in FIG. 12, in step S300, the ECU 10 obtains the lighting color of the traffic light S.

Next, in step S305, the ECU 10 determines whether or not the lighting color of the traffic light S could be obtained. In the case where the lighting color of the traffic light S could not be obtained (No), the ECU 10 proceeds to step S400. Meanwhile, in the case where the lighting color of the traffic light S could be obtained (Yes), the ECU 10 proceeds to step S310.

In step S400, the ECU 10 determines whether or not any preceding vehicle to follow is present. In the case where the ECU 10 determines that no preceding vehicle to follow is present (No), the ECU 10 proceeds to step S410. In step S410, the ECU 10 assumes that the lighting color of the traffic light S is red and executes the deceleration and stop control for causing the vehicle V to decelerate at the second deceleration rate A2. Also, the ECU 10 displays the red light portion lighting image 80B (see FIG. 6) on the display apparatus 61. At that time, the ECU 10 may additionally display on the display apparatus 61 a message image or the like which notifies the driver that the ECU 10 causes the vehicle V to travel under the assumption that the lighting color of the traffic light S is red. After having executed the deceleration and stop control in step S410, the ECU 10 returns to step S300.

Meanwhile, in the case where the ECU 10 determines in step S400 that a preceding vehicle to follow is present (Yes), the ECU 10 proceeds to step S420. In step S420, the ECU 10 determines whether or not the deceleration rate A′ (absolute value) of the preceding vehicle is higher than the second deceleration rate A2 (absolute value). In the case where the deceleration rate A′ of the preceding vehicle is higher than the second deceleration rate A2 (Yes), the ECU 10 proceeds to step S430 and causes the vehicle V to decelerate while following the preceding vehicle by the follow-up control. At that time, preferably, the ECU 10 displays on the display apparatus 61 the preceding vehicle follow-up image 86 (see FIGS. 9 and 10) which notifies the driver that the deceleration causing object is the preceding vehicle. After having caused the vehicle V in step S430 to decelerate by the follow-up control, the ECU 10 returns to step S300.

Meanwhile, in the case where the ECU 10 determines in step S420 that the deceleration rate A′ of the preceding vehicle is equal to or smaller than the second deceleration rate A2 (No), the ECU 10 proceeds to step S410. Namely, the ECU 10 executes the deceleration and stop control for decelerating the vehicle V at the second deceleration rate A2 without causing the vehicle V to follow the preceding vehicle.

In the case where the ECU 10 determines in step S305 that the lighting color of the traffic light S could be obtained and then proceeds to step S310, the ECU 10 determines whether or not the obtained lighting color is green. In the case where the lighting color is green (Yes), the ECU 10 proceeds to step S500. Meanwhile, in the case where the lighting color is not green (No); namely, the lighting color is red or yellow, the ECU 10 proceeds to S320.

In step S500, the ECU 10 obtains the distance DS between the closest traffic light S1 and the next traffic light S2 located ahead of and adjacent to the traffic light S1 on the basis of the map data 51 of the navigation system 50 and the present position VP of the vehicle V. Subsequently, in step S510, the ECU 10 determines whether the distance DS is equal to or shorter than the predetermined threshold distance DSth. In the case where the distance DS is equal to or shorter than the threshold distance DSth (Yes), the ECU 10 proceeds to step S520. Meanwhile, in the case where the distance DS is not equal to or shorter than the threshold distance DSth (No); namely, the distance DS is longer than the threshold distance DSth, the ECU 10 proceeds to step S570.

In step S570, the ECU 10 causes the vehicle V to pass the traffic light S1 by the ACC. Namely, in the case where the set speed Vd of the ACC is higher than the target speed V1, the ECU 10 causes the vehicle V to pass the traffic light S1 while accelerating the vehicle V such that the vehicle speed Vs increases to the set speed Vd. After that, the ECU 10 ends the current execution of the present routine (returns to an unillustrated original routine).

In the case where the ECU 10 determines in step S510 that the distance DS is equal to or shorter than the threshold distance DSth and then proceeds to step S520, the ECU 10 determines whether or not any preceding vehicle to follow is present. In the case where the ECU 10 determines that no preceding vehicle to follow is present (No), the ECU 10 proceeds to step S530 and executes the constant speed travel control for causing the vehicle V to travel at the target speed V1; i.e., travel at a constant speed. At that time, the ECU 10 displays the green light portion lighting image 80D (see FIG. 8) on the display apparatus 61. Namely, the ECU 10 notifies the driver that the ECU 10 causes the vehicle V to travel at a constant speed while recognizing that the lighting color of the traffic light S is green.

Meanwhile, in the case where the ECU 10 determines in step S520 that a preceding vehicle to follow is present (Yes), the ECU 10 proceeds to step S540 and determines whether or not the speed V′ of the preceding vehicle is higher than the target speed V1. In the case where the speed V′ of the preceding vehicle is higher than the target speed V1 (Yes), if the ECU 10 causes the vehicle V to follow the preceding vehicle, the vehicle speed Vs exceeds the target speed V1. In this case, the ECU proceeds to step S530 so as to execute the constant speed travel control for causing the vehicle V to travel at the target speed V1; i.e., travel at a constant speed. Meanwhile, in the case where the speed V′ of the preceding vehicle is not higher than the target speed V1 (No); namely, in the case where the speed V′ of the preceding vehicle is equal to or lower than the target speed V1, even when the ECU 10 causes the vehicle V to follow the preceding vehicle, the vehicle speed Vs does not exceed the target speed V1. In this case, the ECU proceeds to step S550 and causes the vehicle V to follow the preceding vehicle by the follow-up control.

In step S560, the ECU 10 determines whether or not the vehicle V has passed the traffic light S1. In the case where the vehicle V has not yet passed the traffic light S1 (No), the ECU 10 returns to step S520. Meanwhile, in the case where the vehicle V has passed the traffic light S1 (Yes), the ECU 10 ends the current execution of the present routine (returns to the original routine). After that, at a point in time when the lighting color of the next traffic light S2 is obtained, in accordance with the lighting color, the ECU 10 executes control similar to the control performed when the vehicle has passed the traffic light S1.

In the case where the ECU 10 determines in step S310 that the lighting color of the traffic light S is not green and then proceeds to step S320, the ECU 10 determines whether or not any preceding vehicle to follow by the ACC is present. In the case where the ECU 10 determines that a preceding vehicle to follow is present (Yes), the ECU 10 proceeds step S350. Meanwhile, in the case where no preceding vehicle to follow is present (No), the ECU 10 proceeds to step S330.

In step S350, the ECU 10 determines whether or not the deceleration rate A′ (absolute value) of the preceding vehicle is higher than the second deceleration rate A2 (absolute value) used in the deceleration and stop control. In the case where the deceleration rate A′ of the preceding vehicle is higher than the second deceleration rate A2, if the deceleration and stop control is executed, the inter-vehicle distance between the vehicle V and the preceding vehicle becomes shorter than the set inter-vehicle distance Dd. In this case, the ECU 10 proceeds to step S360 so as to execute the follow-up control by the ACC. At that time, preferably, the ECU 10 displays on the display apparatus 61 the preceding vehicle follow-up image 86 (see FIGS. 9 and 10) which notifies the driver that the deceleration causing object is the preceding vehicle.

In the case where the ECU 10 determines in step S350 that the deceleration rate A′ of the preceding vehicle is equal to or smaller than the second deceleration rate A2 (No), the ECU 10 must execute the deceleration and stop control even when the preceding vehicle does not decelerate. In this case, the ECU 10 proceeds to step S330.

In step S330, the ECU 10 executes the deceleration and stop control for causing the vehicle V to decelerate at the second deceleration rate A2 and stop at the stop position PST before the traffic light S. Also, the ECU 10 displays on the display apparatus 61 the red light portion lighting image 80B (see FIG. 6) which notifies the driver that the deceleration causing object is the traffic light S whose lighting color could be recognized by the camera 43. Namely, the ECU 10 notifies the driver that the deceleration causing object is the traffic light S recognized by the camera 43.

In step S370, the ECU 10 determines whether or not the vehicle V has stopped at the stop position PST before the traffic light S. In the case where the vehicle V has not yet stopped at the stop position PST (No), the ECU 10 returns to step S320. Meanwhile, in the case where the vehicle V has stopped at the stop position PST (Yes), the ECU 10 ends the display of the red light portion lighting image 80B on the display apparatus 61 and ends the current execution of the present routine (returns to the original routine).

In the present embodiment having been described in detail above, the ECU 10 detects a traffic light S present ahead of the vehicle Von the basis of the map data 51 of the navigation system 50 and computes the deceleration start point Psd associated with the detected traffic light S. In the case where the vehicle speed Vs at the time when the vehicle V reaches the deceleration start point Psd is higher than the target speed V1, the ECU 10 executes the gentle deceleration control for decelerating the vehicle V at the first deceleration rate A1 to the target speed V1. At that time, the ECU 10 displays the no light portion lighting image 80A on the display apparatus 61. Also, when the vehicle V reaches the recognizable point Pr, the ECU 10 obtains the lighting color of the traffic light S ahead of the vehicle V by the camera 43. In the case where the obtained lighting color is red or yellow, the ECU 10 executes the deceleration and stop control for decelerating the vehicle V at the second deceleration rate A2 higher than the first deceleration rate A1 and stopping the vehicle V1 before the traffic light S. At that time, the ECU 10 displays the red light portion lighting image 80B on the display apparatus 61.

Namely, the ECU 10 is configured to selectively display the different notification images 80A and 80B on the display apparatus 61 depending on whether the ECU 10 executes the gentle deceleration control or the deceleration and stop control. As a result, it becomes possible to effectively notify the driver whether the deceleration causing object is the traffic light S detected on the basis of the map data 51 of the navigation system 50 or the traffic light S which is recognized by the camera 43 that its lighting color is red or yellow. Since the driver can grasp the deceleration causing object, it becomes possible for the driver to effectively monitor the deceleration control to determine whether or not the deceleration control is performed appropriately, while paying attention to the situation around the vehicle. Accordingly, it becomes possible to enhance safety without fail.

Although the notification control apparatus, the vehicle, the notification control method, and the program according to the present embodiment have been described, the present invention is not limited to the above-described embodiment, and various modifications can be made without departing from the object of the present invention.

For example, in the above-described embodiment, the lighting colors of the traffic lights S1 and S2 are obtained by the camera 43. However, the ECU 10 may be configured to obtain pieces of information representing the signal colors of the traffic lights S1 and S2 through data communication with an infrastructure such as a traffic control center.

What is claimed is:

1. A notification control apparatus which is applied to a vehicle and which controls a notification apparatus which gives a notice to a driver of the vehicle, the vehicle having a driving assistance apparatus which comprises a first recognition section which recognizes a traffic light present ahead of the vehicle on the basis of map data including pieces of information of traffic lights on a road on which the vehicle travels, a second recognition section which recognizes the traffic light present ahead of the vehicle and an indication state of the traffic light, and a deceleration control section which executes deceleration control for decelerating the vehicle at a predetermined deceleration rate by using, as a deceleration causing object, a traffic light which is recognized by at least one of the first recognition section and the second recognition section in a period during which the vehicle is traveling,
the notification control apparatus comprising a control section which controls the notification apparatus to notify the driver of the deceleration causing object associated with the deceleration control in different manners between the case where the deceleration control section executes the deceleration control by using, as the deceleration causing object, the traffic light recognized by the first recognition section and the case where the deceleration control section executes the deceleration control by using, as the deceleration causing object, the traffic light recognized by the second recognition section.

2. A notification control apparatus according to claim 1, wherein the notification apparatus is a display apparatus which is provided at a position determined such that the driver of the vehicle can view the display apparatus, and
wherein, when the deceleration control is executed by using, as the deceleration causing object, the traffic light recognized by the first recognition section, the control section displays an image of a traffic light on the display apparatus in such a manner that none of lighting portions of the traffic light is on, and, when the deceleration control is executed by using, as the deceleration causing object, the traffic light recognized by the second recognition section, the control section displays an image of a traffic light on the display apparatus in such a manner that a lighting portion of the traffic light corresponding to the indication state is on.

3. A vehicle comprising a driving assistance apparatus and a notification control apparatus as set forth in claim 1, wherein the deceleration control section decelerates the vehicle at different deceleration rates between the case where the deceleration control section executes the deceleration control by using, as the deceleration causing object, the traffic light recognized by the first recognition section and the case where the deceleration control section executes the deceleration control by using, as the deceleration causing object, the traffic light recognized by the second recognition section.

4. A vehicle according to claim 3, wherein the second recognition section becomes able to recognize the lighting color of the traffic light when a distance between the vehicle and a traffic light ahead of the vehicle becomes a predetermined threshold distance or shorter, and
wherein, in the case where a speed of the vehicle is higher than a predetermined target vehicle speed when the vehicle reaches a predetermined point before a point where the distance between the vehicle and the traffic light recognized by the first recognition section becomes the threshold distance or shorter, the deceleration control section executes first deceleration control for decelerating the vehicle at a predetermined first deceleration rate from a point in time when the vehicle reaches the predetermined point, and, in the case where the second recognition section recognizes the lighting color of the traffic light ahead of the vehicle and the recognized lighting color is red or yellow, from a point in time when the lighting color of the traffic light is recognized, the deceleration control section executes second deceleration control for decelerating the vehicle at a predetermined second deceleration rate higher than the first deceleration rate.

5. A notification control method which is applied to a vehicle and which controls a notification apparatus which gives a notice to a driver of the vehicle, the vehicle having a driving assistance apparatus which comprises a first recognition section which recognizes a traffic light present ahead of the vehicle on the basis of map data including pieces of information of traffic lights on a road on which the vehicle travels, a second recognition section which recognizes the traffic light present ahead of the vehicle and an indication state of the traffic light, and a deceleration control section which executes deceleration control for decelerating the vehicle at a predetermined deceleration rate by using, as a deceleration causing object, a traffic light which is recognized by at least one of the first recognition section and the second recognition section in a period during which the vehicle is traveling,
wherein the notification control method controls the notification apparatus to notify the driver of the deceleration causing object associated with the deceleration control in different manners between the case where the deceleration control section executes the deceleration control by using, as the deceleration causing object, the traffic light recognized by the first recognition section and the case where the deceleration control section executes the deceleration control by using, as the deceleration causing object, the traffic light recognized by the second recognition section.

6. A program which is applied to a vehicle and which controls a notification apparatus which gives a notice to a driver of the vehicle, the vehicle having a driving assistance apparatus which comprises a first recognition section which recognizes a traffic light present ahead of the vehicle on the basis of map data including pieces of information of traffic lights on a road on which the vehicle travels, a second recognition section which recognizes the traffic light present ahead of the vehicle and an indication state of the traffic light, and a deceleration control section which executes deceleration control for decelerating the vehicle at a predetermined deceleration rate by using, as a deceleration causing object, a traffic light which is recognized by at least one of the first recognition section and the second recognition section in a period during which the vehicle is traveling,
wherein the program causes a computer to execute a process of controlling the notification apparatus to notify the driver of the deceleration causing object associated with the deceleration control in different manners between the case where the deceleration control section executes the deceleration control by using, as the deceleration causing object, the traffic light recognized by the first recognition section and the case where the deceleration control section executes the deceleration control by using, as the deceleration causing object, the traffic light recognized by the second recognition section.
